(19) United States
(12) Patent Application Publication
(10) Pub. No.: US 2011/0233913 A1
(43) Pub. Date: Sep. 29, 2011

(54) Spiral bound notebook with removable sheets

(76) Inventor: Sheng-Tan Wang, Changhua (TW)

(21) Appl. No.: 12/729,256

(22) Filed: Mar. 23, 2010

(51) Int. Cl. B42D 1/00

(52) U.S. Cl. 281/27.2

(57) ABSTRACT

A spiral bound notebook includes a plurality of sheets of paper each having a plurality of equally spaced holes adjacent one side, each hole having a slit with one open end extending to the edge of one side of the sheet of paper; and a binding mechanism comprising a plurality of flexible C-shaped rings connected together. A removed sheet of paper can be intact without damage.

### BACKGROUND OF THE INVENTION

1. Field of Invention

The invention relates to spiral bound notebooks and more particularly to such a spiral bound notebook having an arrangement capable of removing sheets of paper without tearing.

2. Description of Related Art

A typical spiral bound notebook A is shown in FIG. 1 and comprises a helical wire B looping through larger perforations A2 of sheets of paper A1. However, a plurality of cracks each extending from the perforation A2 to the edge are generated after removing a desired sheet of paper A1. To the worse, it is possible of leaving a portion of sheet of paper A3 on one corner of the sheets of paper A1 after the removal. All of these drawbacks are not desired.

Another typical notebook is shown in FIGS. 2A, 2B and 2C. The notebook comprises a plurality of disc-shaped members C formed of plastic. Each disc-shaped member C has two opposite recessed faces C1. A plurality of sheets of paper D each has a plurality of punched holes D1 along one side line. Each hole D1 is shaped as a half circle and has a slit D2 having one end terminating at one side of the sheet of paper D.

In a binding process, a person may push the disc-shaped member C through the slit D2 until the wider ring-shaped edge of the disc-shaped member C is disposed in the hole D1 for locking. The above step can be repeated a plurality of times until all holes D1 are looped through by the disc-shaped members C. This completes a single page binding. A plurality of sheets of paper D can be bound by repeating the single page binding process.

However, this binding process is time consuming. Thus, the need for improvement still exists.

### SUMMARY OF THE INVENTION

It is therefore one object of the invention to provide a spiral bound notebook comprising a plurality of sheets of paper each having a plurality of equally spaced holes adjacent one side, each hole having a slit with one open end extending to the edge of one side of the sheet of paper; and a binding mechanism comprising a plurality of flexible C-shaped rings connected together.

The above and other objects, features and advantages of the invention will become apparent from the following detailed description taken with the accompanying drawings.

### BRIEF DESCRIPTION OF THE DRAWINGS

FIG. 1 is a perspective view of a typical spiral bound notebook being open;

FIG. 2A is an exploded view of another typical notebook;

FIG. 2B is a cut-away perspective view of the disc-shaped member of FIG. 2A;

FIG. 2C is a perspective view of the assembled notebook of FIG. 2A;

FIG. 3 is an exploded view showing a step of binding sheets of paper according to a spiral bound notebook of the invention;

FIG. 4 is an enlarged view of the right portion of FIG. 3;

FIG. 5 is another enlarged view of FIG. 4 further showing another step of binding;

FIG. 6 is a perspective view of FIG. 5 showing its assembled state;

FIG. 7 is a perspective view showing a removal of a single sheet of paper from the spiral bound notebook of the invention; and

FIGS. 8, 9 and 10 are perspective views each showing a portion of a sheet of paper with punched holes of different shapes.

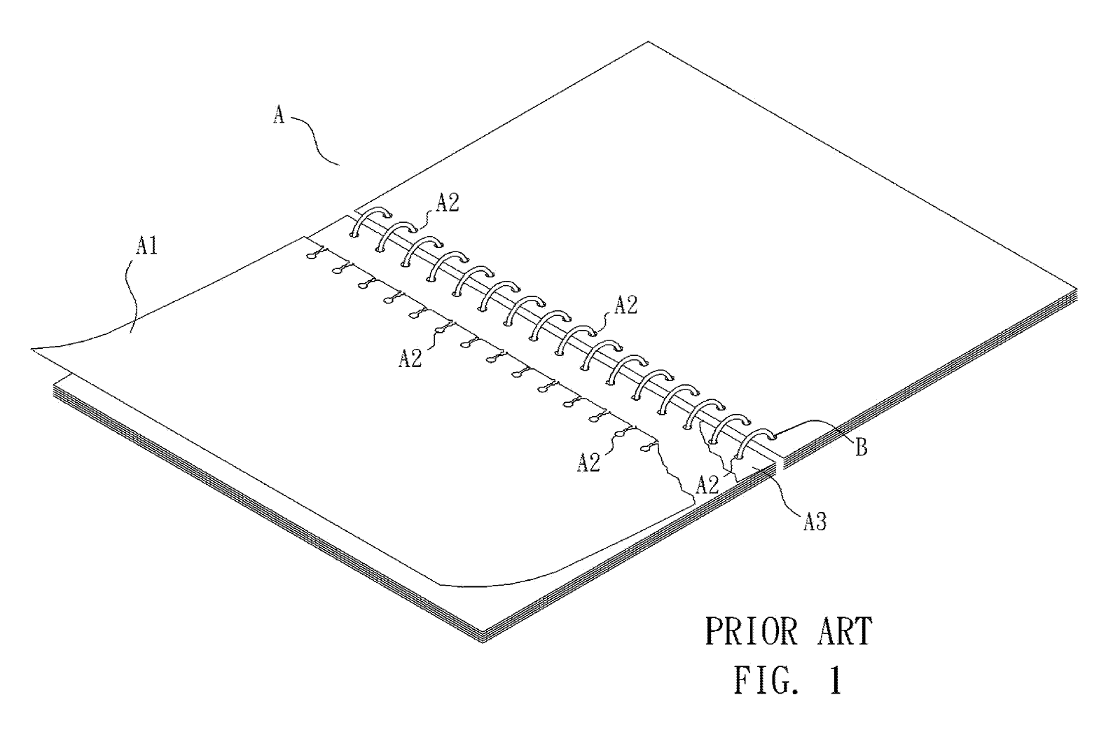

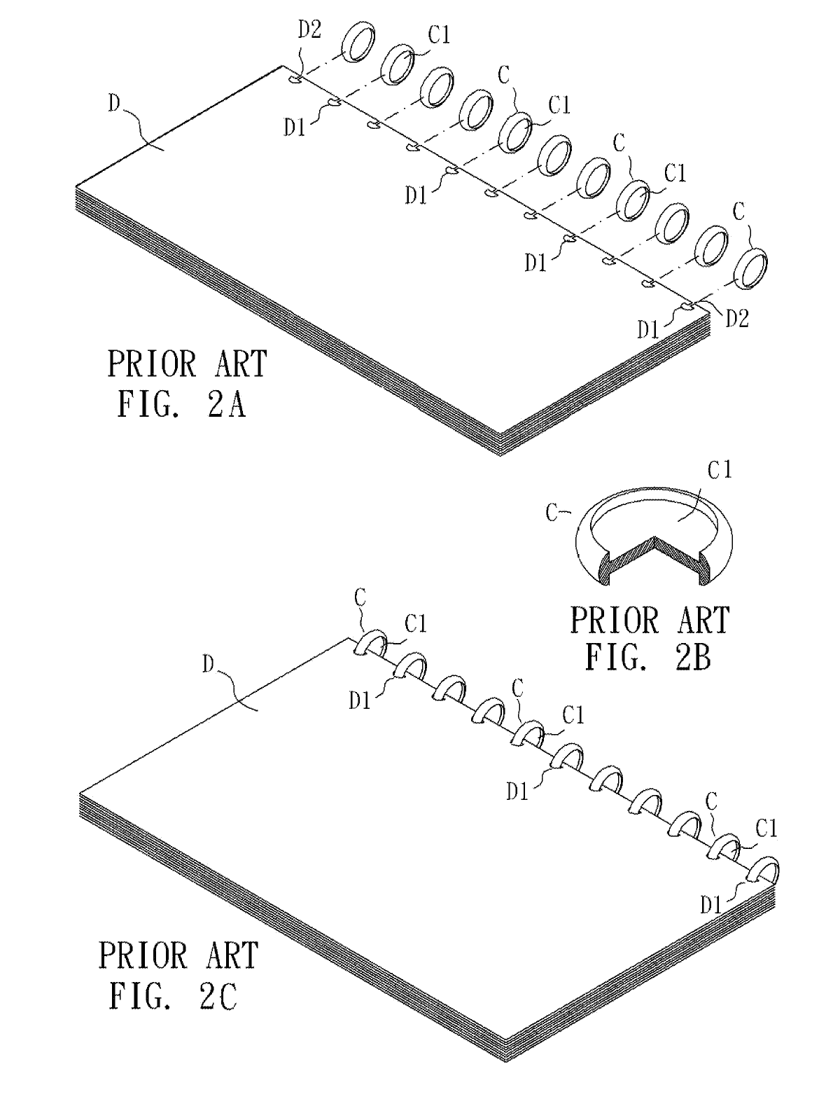

### DETAILED DESCRIPTION OF THE INVENTION

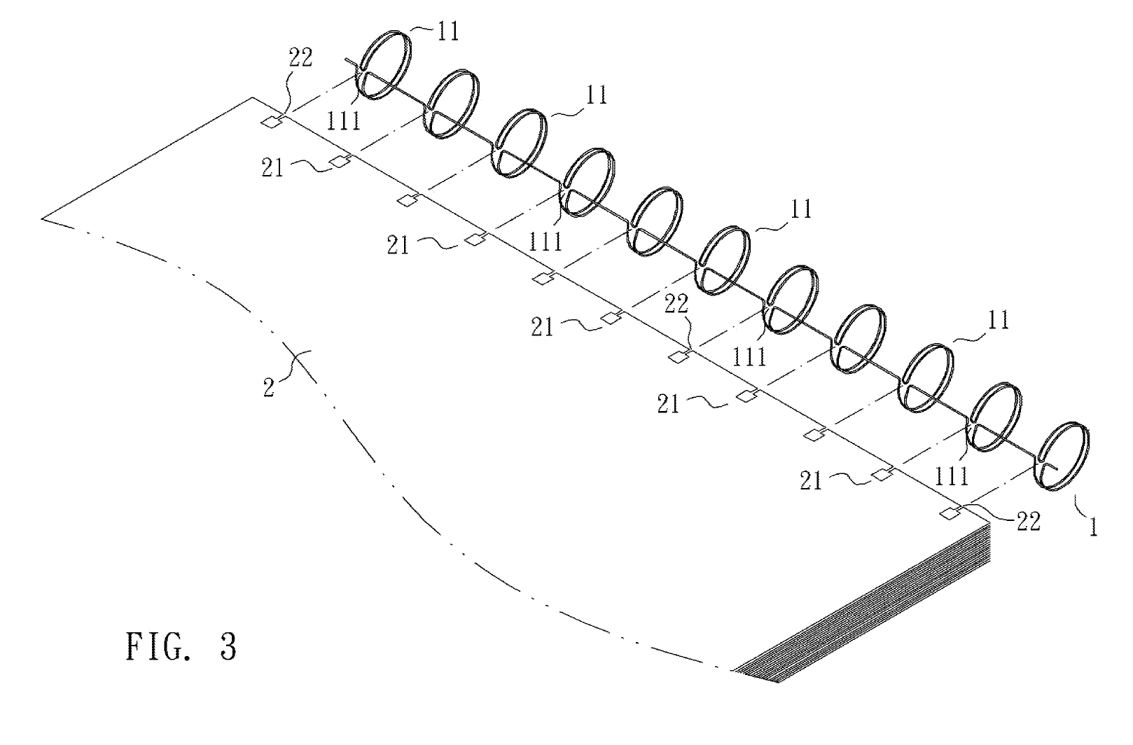

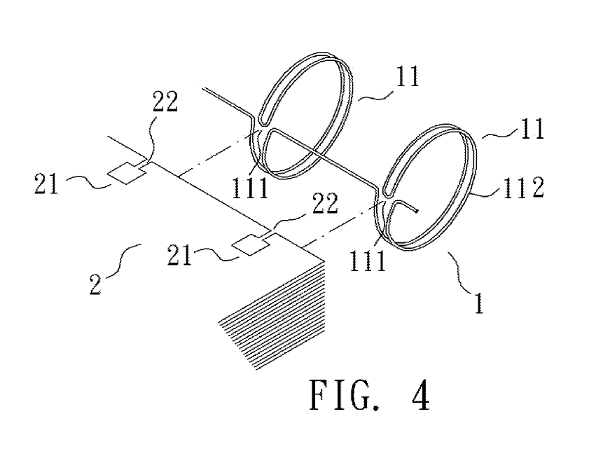

Referring to FIGS. 3 to 7, a spiral bound notebook in accordance with the invention comprises the following components as discussed in detail below.

A plurality of rectangular sheets of paper 2 each has a plurality of equally spaced, rectangular holes 21 formed by punching a straight line adjacent one side. Each hole 21 has a slit 22 having one end extending to the edge of the side.

A helical wire 1 is wound into a plurality of C-shaped rings 11 each having two opposite wire sections 112 and an opening 111. Preferably, any two adjacent C-shaped rings 11 are spaced by one inch. The binding mechanism formed by the helical wire 1 is thus resilient, flexible and robust.

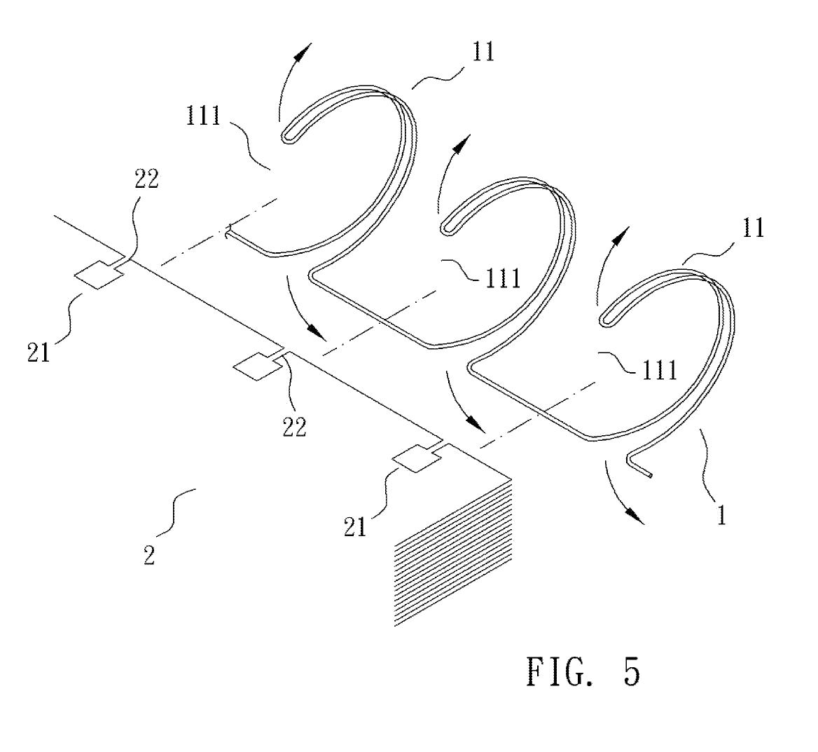

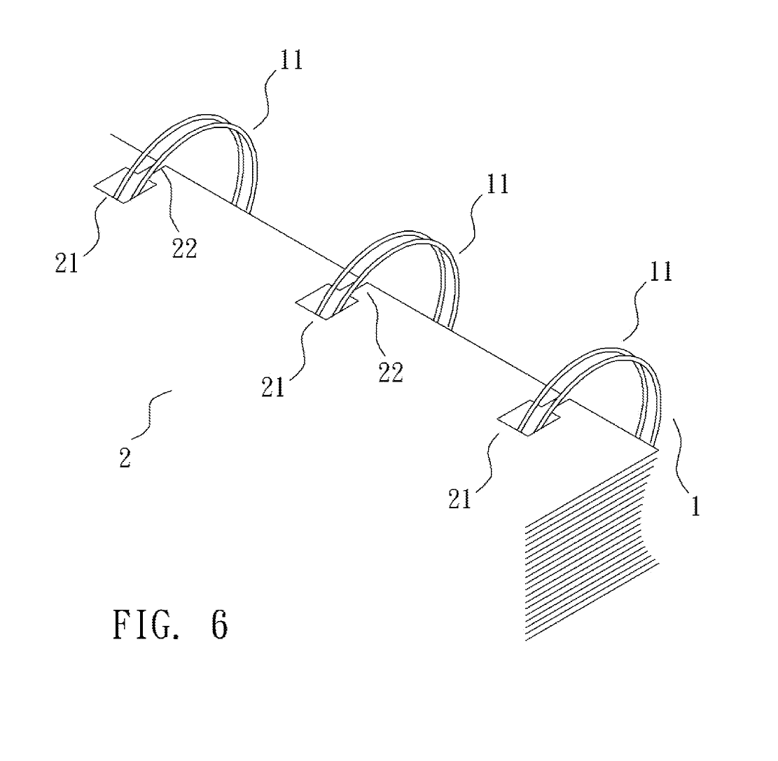

In a binding process, a plurality of sheets of paper 2 can be stacked together. Next, an employee may enlarge the openings 111 by pulling $ opening 111 upward (see FIG. 5). Next, place the sides of the sheets of paper 2 in the openings 111 and then align the ends of the C-shaped rings 11 with the holes 21. Next, slowly release the C-shaped rings 11 until it loops through the holes 21. As a result, a notebook is bound (see FIG. 6). It is noted that the width of the C-shaped ring 11 is sufficiently greater than that of the slit 22 and less than that of the hole 21. Hence, the sheets of paper 2 are lockingly bound without worrying being removed unintentionally. A user may turn the sheet of paper (or sheets of paper) 2 to find his or her desired page in a manner known in the art. Thereafter, the user may pull the sheet of paper 2 rightward to cause the holes 21 to clear the C-shaped rings 11 along the slits 22 (see FIG. 7). It is seen that the removed sheet of paper 2 is intact without damage. To the contrary, the user may bind a sheet of paper 2 to the notebook by pushing the sheet of paper 2 leftward in a manner already discussed in the above paragraph (see FIG. 7).

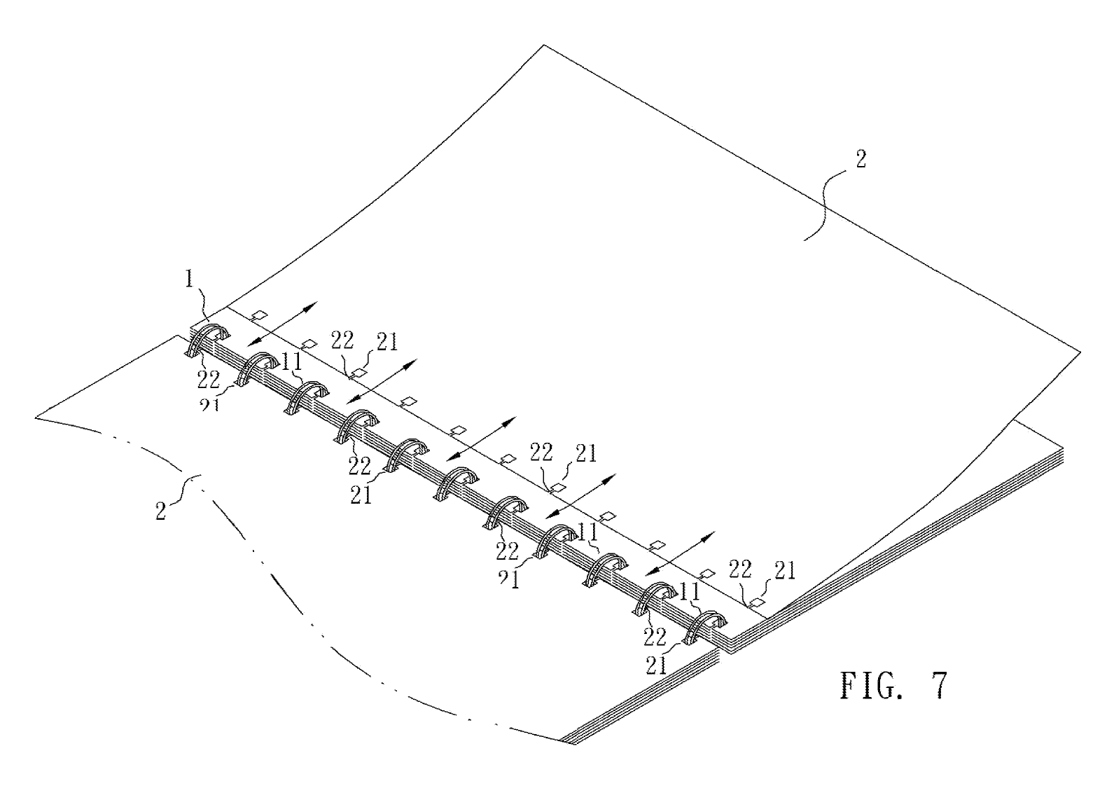

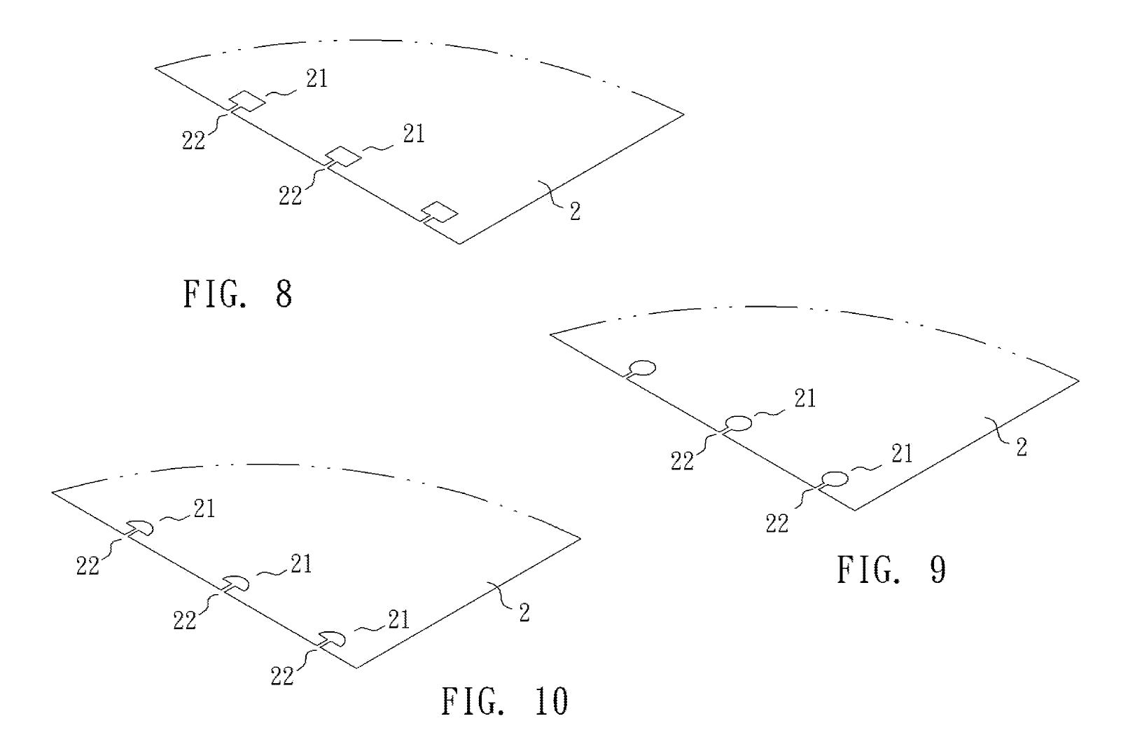

Referring to FIG. 8, the sheet of paper 2 may have a plurality of rectangular punched holes 21 each having a slit 22 extending to the edge in a first preferred embodiment.

Referring to FIG. 9, the sheet of paper 2 may have a plurality of circular punched holes 21 each having a slit 22 extending to the edge in a second preferred embodiment.

Referring to FIG. 10, the sheet of paper 2 may have a plurality of half circular punched holes 21 each having a slit 22 extending to the edge in a third preferred embodiment.

While the invention herein disclosed has been described by means of specific embodiments, numerous modifications and variations could be made thereto by those skilled in the art without departing from the scope and spirit of the invention set forth in the claims.

What is claimed is:

1. A spiral bound notebook comprising:
a plurality of sheets of paper each comprising a plurality of equally spaced holes adjacent one side, each hole including a slit with one open end extending to the edge of one side of the sheet of paper; and
a binding mechanism comprising a plurality of flexible C-shaped rings connected together.

2. The spiral bound notebook of claim 1, wherein the width of the C-shaped ring is greater than that of the slit.

3. The spiral bound notebook of claim 1, wherein each C-shaped ring further comprises two opposite wire sections.
